(19) United States
(12) Patent Application Publication
(10) Pub. No.: US 2020/0020048 A1
(43) Pub. Date: Jan. 16, 2020

(54) METHOD OF PROVIDING WIRED PIPE DRILL SERVICES

(71) Applicants: John Macpherson, Spring, TX (US); Fernando Lopez, Houston, TX (US); Ralf Mieting, Celle (DE); Thomas Heimes, Celle (DE)

(72) Inventors: John Macpherson, Spring, TX (US); Fernando Lopez, Houston, TX (US); Ralf Mieting, Celle (DE); Thomas Heimes, Celle (DE)

(73) Assignee: Baker Hughes, a GE company, LLC, Houston, TX (US)

(21) Appl. No.: 16/512,708

(22) Filed: Jul. 16, 2019

Related U.S. Application Data
(60) Provisional application No. 62/698,410, filed on Jul. 16, 2018.

(51) Int. Cl. G06Q 50/02; E21B 17/00; E21B 47/12; E21B 17/02; G06Q 30/06

(52) U.S. Cl. CPC G06Q 50/02; E21B 17/003; G06Q 30/0645; E21B 17/028; E21B 47/12

(57) ABSTRACT

A method of providing wired pipe drill services to an oil field operational participant includes providing a durable drilling component to the oil field operational participant, providing the durable element including receiving a sale payment from the oil field operational participant. The method can include either or both of providing a plurality short life wired pipe drilling components to the oil field operational participant, providing the short life wired pipe drilling components including receiving a rental fee from the oil field operational participant, wherein the rental fee includes an operation cost portion that is based on a data rate to be used by the short life wired pipe drilling components and providing a software product to the oil field operational participant, the software product allowing for the reception of data from at least one of the short life wired pipe drilling components.

### PRIORITY

This application claims priority to U.S. Provisional Application 62/698,410, filed Jul. 16, 2018 the contents of which are incorporated in their entirety.

### BACKGROUND

During subterranean drilling and completion operations, a pipe or other conduit is lowered into a borehole in an earth formation during or after drilling operations. Such pipes are generally configured as multiple pipe segments to form a “string”, such as a drill string or production string.

There are many types of tools for drilling a borehole into an earth formation or for characterizing the formation by performing measurements from the borehole. These tools are typically disposed at the distal end of the drill string used to drill the borehole with a rotating drill bit. The arrangement of the downhole tools is generally referred to as a bottomhole assembly (BHA).

Various power and/or communication signals may be transmitted between portions of the BHA and through the pipe segments via a “wired pipe” configuration. Such configurations include electrical, optical or other conductors extending along the BHA or pipe segments. The conductors are operably connected between tools of the BHA or pipes of the wired pipe system by a variety of coupling configurations.

One such coupling configuration includes a threaded male-female configuration often referred to as a pin-box connection. The pin box connection includes a male member, i.e., a “pin” that includes an exterior threaded portion, and a female member, i.e., a “box”, that includes an interior threaded portion and is configured to receive the pin in a threaded connection.

Some BHA and wired pipe configurations include a transmission device (referred to as coupler below) mounted on the shoulders of the pin/box ends. The transmission device can transmit power, data or both to an adjacent transmission device. In such instances, a repeater can be placed between the transmission device of one pipe segment and the transmission device of another pipe segment.

### BRIEF DESCRIPTION

Disclosed herein is a method of providing wired pipe drilling services to an operator. Herein, an operator can be a drilling contractor or an oil company operator. The method includes: providing a durable drilling component to the operator, providing the durable element including receiving a sale payment from the operator; and providing a plurality short life wired pipe drilling components to the operator, providing the short life wired pipe drilling components including receiving a rental fee from the operator, wherein the rental fee includes an operation cost portion that is based on a data rate to be used by the short life wired pipe drilling components.

Also disclosed is method of providing wired pipe drilling services to an operator of a drilling rig that includes providing a short life wired pipe drilling component to the operator, providing the short life wired pipe drilling component including receiving a rental fee from the operator, wherein the rental fee includes an operation cost portion that is based on a data rate to be used by the short life wired pipe drilling component. This method also includes providing a software product to the operator, the software product allowing for the reception of data from at least one of the short life wired pipe drilling components, wherein providing includes licensing the software product to the operator.

### BRIEF DESCRIPTION OF THE DRAWINGS

The following descriptions should not be considered limiting in any way. With reference to the accompanying drawings, like elements are numbered alike:

FIG. 1 depicts a cross-sectional view of a downhole system according to aspects of the present disclosure;

FIG. 2 depicts a cross-section of a box end of a pipe segment according to one embodiment;

FIG. 3 depicts a cross-section of a pin end of a pipe segment according to one embodiment;

FIG. 4 is a perspective view of repeater according to one embodiment;

FIG. 5 is a cross-section of pipe segment that includes a repeater disposed therein;

FIG. 6 is partial cut-way and exploded view of a pipe segment including a repeater and communication infrastructure;

FIG. 7 is flow chart of a method according to one embodiment; and

FIG. 8 is flow chart of a method according to one embodiment;

### DETAILED DESCRIPTION

A detailed description of one or more embodiments of the disclosed system, apparatus and method are presented herein by way of exemplification and not limitation with reference to the Figures.

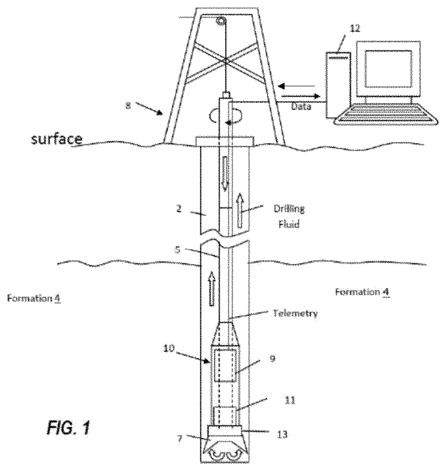

FIG. 1 depicts a cross-sectional view of a wellbore operation 100 according to an embodiment of the present disclosure. The system and arrangement shown in FIG. 1 is one example to illustrate the downhole environment. While the system can operate in any subsurface environment, FIG. 1 shows downhole tools 10 disposed in a borehole 2 penetrating the formation 4. The downhole tools 10 are disposed in the borehole 2 at a distal end of a carrier 5. The downhole tools 10 can include measurement tools 11 and downhole electronics 9 configured to perform one or more types of measurements in an embodiment known as Logging-While-Drilling (LWD) or Measurement-While-Drilling (MWD).

According to the LWD/MWD embodiment, the carrier 5 is a drill string made of several pipe segments and that includes a bottomhole assembly (BHA) 13. The BHA 13 is a part of the drilling rig 8 that includes drill collars, stabilizers, reamers, and the like, and the drill bit 7. The measurements can include measurements related to drill string operation, for example. A drilling rig 8 is configured to conduct drilling operations such as rotating the drill string and, thus, the drill bit 7. The drilling rig 8 also pumps drilling fluid through the drill string in order to lubricate the drill bit 7 and flush cuttings from the borehole 2.

As will be understood by the disclosure below, the data from the carrier 5 and/or the BHA 13 can be transmitted via a wired pipe system to computing device 12 and vice versa.

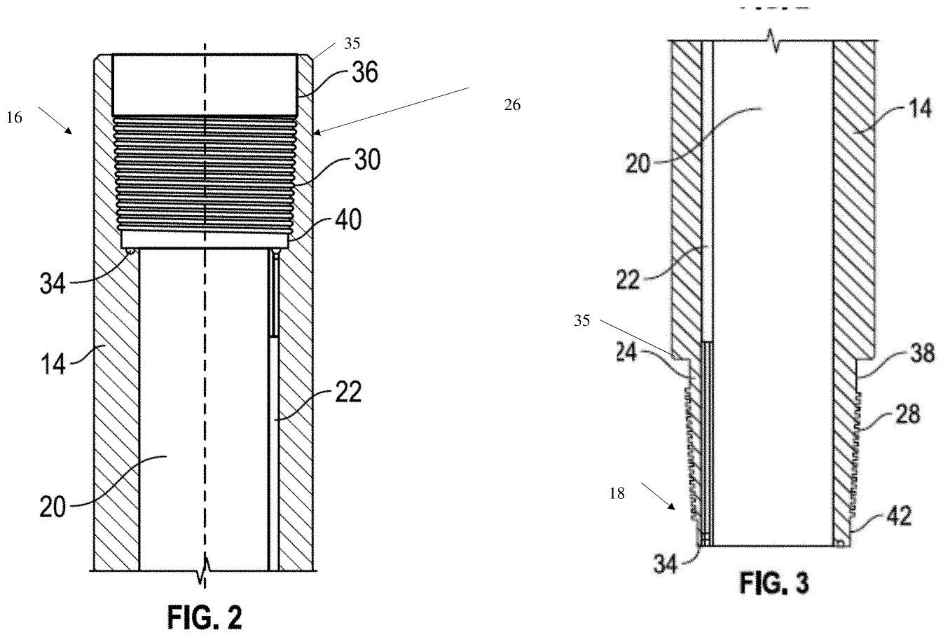

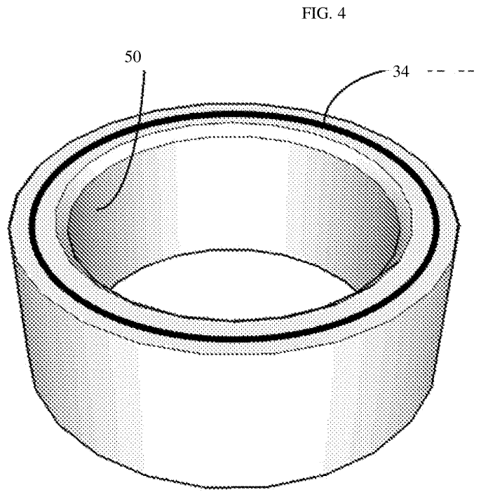

With reference now to FIGS. 2 and 3, the drill string portion of the carrier 4 includes at least one wired pipe segment 14 having an uphole end 16 and a downhole end 18. As described herein, “uphole” refers to a location near the surface relative to a reference location when the segment 14 is disposed in a borehole, and “downhole” refers to a location away from the surface relative to the reference location.

An inner bore or other conduit 20 extends along the length of each segment 14 to allow drilling mud or other fluids to flow therethrough. A transmission line 22 is located within the segment 14 to provide protection for electrical, optical or other conductors to be disposed along the segment 14.

In one embodiment, the transmission line 22 is a coaxial cable. In another embodiment, the transmission line 22 is formed of any manner of carrying power or data, including, for example, a twisted pair. In the case where the transmission line 22 is a coaxial cable it may include an inner conductor surrounded by a dielectric material.

The segment 14 includes an uphole connection 26 and a downhole connection 24. The segment 14 is configured so that the uphole connection 26 is positioned at an uphole location relative to the downhole connection 24. The downhole connection 26 includes a male connection portion 28 having an exterior threaded section, and is referred to herein as a “pin end” 26. The uphole connection 26 includes a female connection portion 30 having an interior threaded section, and is referred to herein as a “box end” 26.

The pin end 24 and the box end 26 are configured so that the pin end 24 can be disposed within the box end 26 to form a fixed connection there between to connect to an adjacent segment 14 or other downhole component. In one embodiment, the exterior of the male connecting portion 28 and the interior of the female connecting portion 30 are tapered along the length of the segment 14 to facilitate connecting. Although the pin end 24 and the box end 26 are described as having threaded portions, the pin 24 and box 26 ends may be configured to be coupled using any suitable mechanism, such as bolts or screws or an interference fit.

In one embodiment, the system 100 is operably connected to a downhole or surface processing unit which may act to control various components of the system 100, such as drilling, logging and production components or subs. Other components include machinery to raise or lower segments 14 and operably couple segments 14. The downhole or surface processing unit may also collect and process data generated by the system 100 during drilling, production or other operations.

As described herein, “drillstring” or “string” refers to any structure or carrier suitable for lowering a tool through a borehole or connecting a drill bit to the surface, and is not limited to the structure and configuration described herein. For example, the carrier 5 of FIG. 1 can be configured as a drillstring, hydrocarbon production string or formation evaluation string.

Referring again to FIGS. 2 and 3, the segment 14 includes at least one transmission device 34 disposed therein and located at the pin end 24 and/or the box end 26. The transmission device 34 is configured to provide communication of at least one of data and power between adjacent segments 14 when the pin end 24 and the box end 26 are engaged. The transmission device 34 may be of any suitable type, such as an inductive coil, capacitive connecting, direct electrical contacts and an optical connection ring. In one embodiment, the transmission device 34 may be a resonant coupler. As shown, the transmission device 34 is inside the pin/box end but this is not meant to be limiting and the external shoulders 35 could include the transmission devices in one embodiment

It shall be understood that the transmission device 34 could also be included in a repeater element disposed between adjacent segments 14 (e.g., within the box end). In such a case, the data/power is transmitted from the transmission device 34 in one segment 14, into the repeater. The signal may then be passed “as is,” amplified, and/or modified in the repeater and provided to the adjacent segment 14. Regardless of the configuration, it shall be understood that each transmission device 34 can be connected to one or more transmission lines 22.

FIG. 4 shows an example of a repeater 50. Such a repeater 50 can include a transmission device 34 disposed therein. Further explanation of the repeater 50 can be found in U.S. Pat. No. 8,941,384, issued Jan. 27, 2015 and which is hereby incorporated by reference in its entirety.

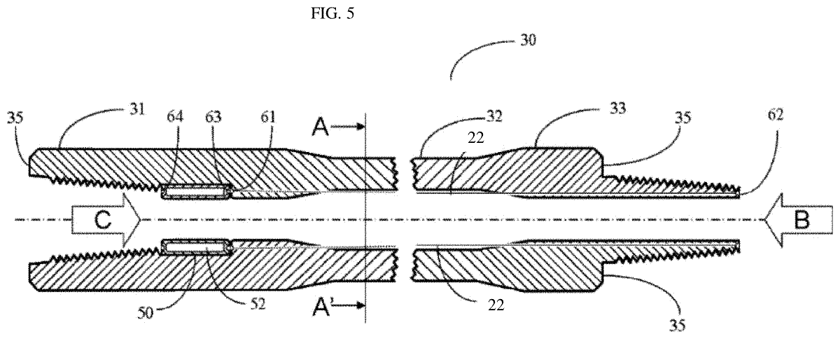

As shown in FIG. 5, the repeater 50 can be disposed in pipe segment 32 having a region in its box end for receiving the repeater. The pipe segment 32, similar to segment 14 above, includes one or more transmission lines. 22, a repeater box 50 and first and second transmission device in the form of electromagnetic resonance (“EMR”) couplers 61 and 62 installed. The boxbox 31 of pipe segment 32 is back-bored by approximately 2 inches (51 mm) to accommodate the repeater box 50. The repeater box 50 houses the EMR couplers 63 and 64. Within the repeater box 50 and sealed from the outside are located numerous typically cylindrically shaped cavities 52 that may house electronic, circuits and batteries. Adjacent cavities 52 may be joined together to simplify electrical connections or to house odd-shaped electrical components. The inwards-facing EMR coupler 63 interfaces with the box-mounted EMR coupler 61. The box-mounted EMR coupler 61 is electrically connected via transmission lines 40 to the pin-mounted EMR coupler 62. When the connection is made, the pin 33 of the adjacent pipe joint engages at shoulders 35 such that the pin-mounted. EMR coupler of the adjacent pipe joint interfaces with EMR coupler 64. Thus, an assembled drill pipe contains a continuous chain of transmission lines 22 that extend the length of the carrier, EMR box couplers 61 and pin couplers 62 and repeater boxes 50 with EMR couplers 63 and 64. Such a chain is capable of transmitting high-speed telemetry data in both directions via radiofrequency carrier signals that are modulated with high-speed data. Such a chain with couplers such as galvanic couplers is also capable of transmitting power useful for powering repeaters, sensor electronics and for recharging rechargeable batteries contained in repeaters and/or sensor electronics.

Having thus given a background on individual pieces of a wired pipe system, some overall operation information is informative. In particular, the pipe segments 14/30 in a wired pipe system can be formed by machining a standard drill pipe to receive a transmission element (e.g. resonant couplers) and the repeaters. In addition, the segment can be machined to receive the transmission lines that can be in the form of an armored coaxial in one embodiment.

In one embodiment, the transmission devices 61, 62, 63 and 64 can each include two or more radio frequency (RF) antennas and can connect to multiple parallel transmission lines, 22. As will be understood by the skilled artisan, such a system can be designed with duplicate pathways and failsafe switches so that several components can fail yet transmission can be maintained. It is therefore reliable. It is also low latency with better than 15 μsec/km delay in one embodiment. As such, a wired pipe system is ideal for control applications and logging from surface.

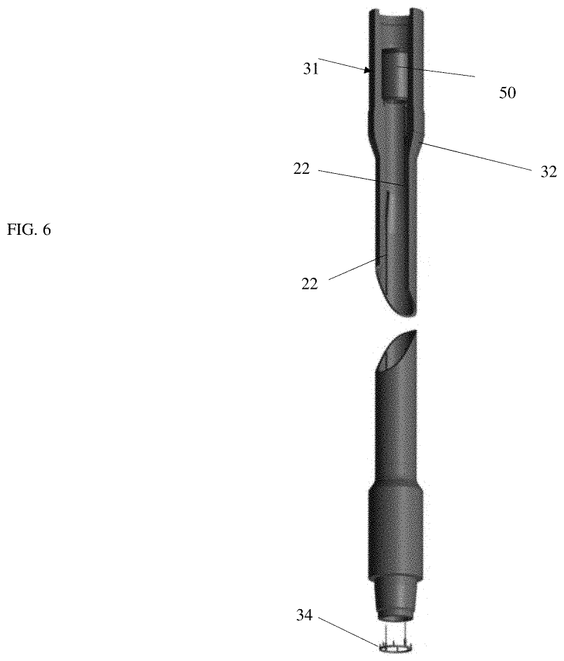

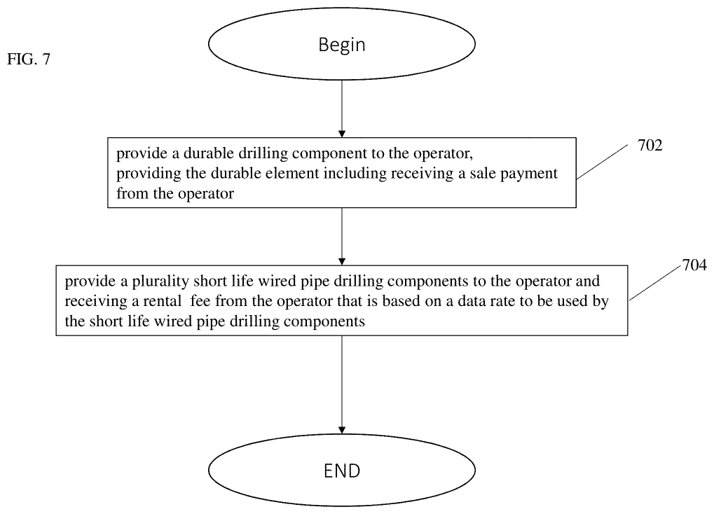

The portions of each pipe segment 32 are shown in FIG. 6. In the following discussion, only segment 32 is referred to but the skilled artisan will realize that the discussion can also be applied to segment 14. The segment 32 can be referred to as durable component herein. Such a segment 32 can be a single shouldered pipe or double shouldered pipe as shown in FIGS. 2/3. Further, a complete wired pipe system can include other durable components such as BHA tubulars, surface interface subs, downhole interface and other surface equipment.

The segment 32 also includes transmission lines 22 and a transmission device 34 disposed therein. These elements form part of a so-called communication infrastructure and are also durable components.

As shown, the box 31 of the segment 32 includes repeater 50 disposed therein. The repeater 50 can include two transmission elements in one embodiment. The repeater 50 can be failsafe (e.g., including redundant transmission lines) and battery powered. The repeater can include memory and be addressable. In addition, the repeaters can contain two transmission devices, and may also include one or more sensors that can provide information about the operating environment of the repeater. Such sensors can be a temperature or acceleration sensors to name but a few. The repeater 50 can thus generate data about itself due to the sensors and memory. Such data can be transmitted to the surface or another location and the amount of data transmitted on the system due to transmission of such data is referred to overhead data herein. Repeaters can be referred to as short life components herein. In such a case, a short life component will have a total useful life that is generally shorter than a durable component. For example, a repeater 50 may last 2 years while a pipe segment 32 may last 5 years.

Further, a wired pipe system will also include related control software that can allow of monitoring of data, electronic tally, along string measurement (ASM) application and software development toolkits (SDKs) which are software products licensed to third parties so that they can develop components that use the wired pipe network. This software can reside, for example, on computing device 12 of FIG. 1 or other microprocessors in the system. Such products can be referred to a software product in one embodiment.

For ASM the repeaters are the access point to the network and can include memory to hold system information such as the length of each element, which adds value to the software component

Based on these implements, a method of providing a wired pipe system for drilling a borehole is disclosed herein. The method can include selling durable components of the system to one or more third parties. The method can also include renting a short life component such as a repeater to a drilling operator or a drilling contractor. The method can also include determining a data transmission rate for operation of the wired pipe system. Based on the transmission rate, an operation cost component is determined. During an operational lifetime of a rental contract of a short life component, the operational cost component is paid by the entity renting the repeater. Thus, the method can also include adding the operation cost to the rental cost.

For instance, each application using the wired pipe will require a certain data rate. There is a base rental cost for short life wired pipe drilling components such as a repeater 50 for instances where low rate (e.g., bandwidth) is used (e.g., below 5 kbps). It has been discovered that such low rates/bandwidths do not affect significantly repeater life. Higher rates reduce may shorten repeater life, and an upcharge in the form of the operational cost is made for these rates. In one embodiment, data transmitted as overhead is not included in the operational cost. As part of the rental, the short life wired pipe drilling component is replaced on a time interval. That time interval can be inversely proportional to the operation cost portion. That is, the more often the component is replaced, the higher the operation cost portion.

It shall be understood herein that certain terminology may be applied to participants in the business of drilling utilizing wired pipe. The participants include: Pipe Supplier (a company providing tubular goods to the industry); Wired Drillpipe Supplier (the company providing the wired pipe system as a whole); Pipe Yard (a company stock piling, supplying, and renting pipe for oilfield operations); Equipment Provider (a company providing equipment to drilling operations); Drilling Contractor (a company providing drilling operations that use the wired pipe); Service Company (company supplying applications and hardware for the wired pipe); and Operator (the prime contractor for drilling operations that use the wired pipe). The term “oil field operational participant” includes all of the above participants.

FIG. 7 shows a flow chart of a method according to one embodiment. While the method shown in FIG. 7 is directed to a method of providing wired pipe drill services to an operator of a drilling rig, it shall be understood that the steps in the method could include any of the participants described above.

In FIG. 7, at block 702 a durable drilling component is provided to the operator. As part of providing the durable element to the operator, a sale payment from the operator can be received from the operator. As discussed above, the operator can be replaced with any of the participants listed above.

In one embodiment, the durable drilling component is a wired pipe segment that is configured to receive one or more elements of a communication infrastructure. As described above, the communication infrastructure can include transmission device (such as a resonant coupler) and one or more transmission lines.

At block 704, a plurality short life wired pipe drilling components are provided to the operator. Again, any of the participants above could take the place of the operator. As part of providing the short life wired pipe drilling components, a rental fee is received from the operator. The rental fee includes a basic rental fee and an operation cost portion that is based on a data rate to be used by the short life wired pipe drilling components.

In one embodiment the short life wired pipe drilling component is a wired pipe repeater. In such an embodiment, the wired pipe repeater transmits payload data and overhead data and the overhead data is not included in the operation cost portion.

The operational cost can be calculated according to:

Operational Cost=recovery factor*(basic rental fee)/Days;

where the recovery factor is a scaling value and can be negotiated between the parties, and Days is a factor based on usage that can be calculated by:

Days=MinLIFE+(LIFE−MinLIFE)*(MaxDR−DR)/(Max−MinDR);

where: DR is a data rate (typically in kbps) to be used in the wired pipe system, MinDR is the minimum data rate of the repeater (e.g., 5 kbps), MaxDR is the maximum data rate for the repeater (e.g., 720 kbps), LIFE is an estimated life of the repeater if it runs at MinDR (e.g, 2 years) and MinLIFE an estimated life of the repeater it is operates at MaxDR (e.g., 210 days).

In some cases, the repeaters 50 are replaced on a regular time interval (e.g, bi-yearly). Repeaters using high data rates have been shown to wear out faster. Once worn out, the repeaters can no longer be part of the replacement stock. As such, the operation cost ensures that the users that wear out repeaters 50 at a faster rate, will pay extra for that usage. That is, the more often the component is replaced, the higher the operation cost portion.

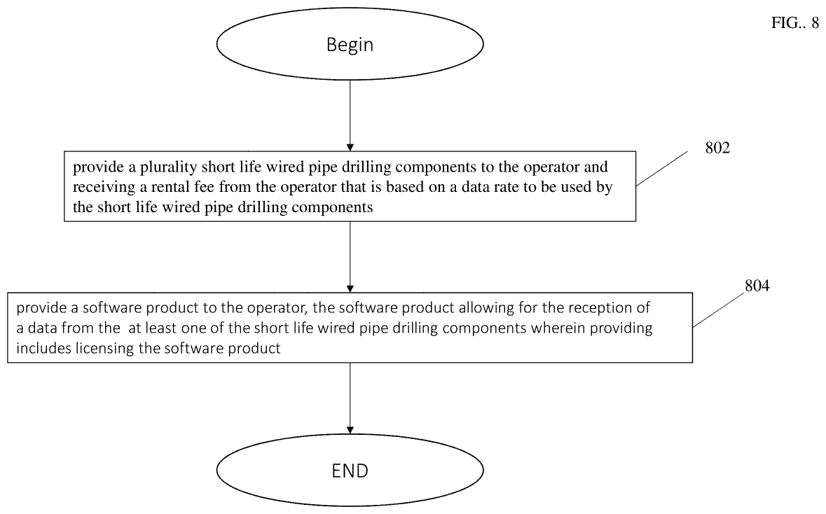

FIG. 8 shows a method according to another embodiment. In block 802 a plurality of short life wired pipe drilling components are provided to the operator. Again, any of the participants above could take the place of the operator. As part of providing the short life wired pipe drilling components, a rental fee is received from the operator. The rental fee includes a basic rental fee and an operation cost portion that is based on a data rate to be used by the short life wired pipe drilling components that can be calculated as described above. Further, and as also described above, in some cases, the repeaters 50 are replaced on a regular time interval (e.g, bi-yearly). Repeaters using high data rates have been shown to wear out faster. Once worn out, the repeaters can no longer be part of the replacement stock. As such, the operation cost ensures that the users that wear out repeaters 50 at a faster rate, will pay extra for that usage.

At block 804 a software product is provided to the operator or other participant. The software product, in one embodiment, allows for the reception of data from the at least one of the short life wired pipe drilling components. In one embodiment, providing the software product includes licensing the software product to the operator/participant.

Based on FIGS. 7 and 8, the skilled artisan will realize that may combinations of different portions of a wired pipe drilling system can be sold or leases/rented to different participants.

In that regard, table 1 below shows different combinations of business arrangements that can be provided:

TABLE 1

| | Pipe | Equipment | Drilling | Service | |
|---|---|---|---|---|---|
| Wired Pipe Company Products | Yard | Provider | Contractor | Company | Operator |
| Machined (Finished) Pipe | SALE | — | SALE | — | SALE |
| Pipe from pipe supplier, machined for wire | | | | | |
| Telemetry Infrastructure Installed in Pipe | SALE | — | SALE/RENT | — | SALE/RENT |
| Transmission lines and devices | | | | | |
| BHA Wired Tubulars | SALE/RENT | — | SALE/RENT | — | SALE/RENT |
| HWDP, Collars, Stabilizers | | | | | |
| Ancilliary Equipment | — | — | RENT | — | RENT |
| Surface Interface Sub, Surface System | | | | | |
| repeaters | — | — | RENT | — | RENT |
| Software Goods | — | — | RENT/LICENSE | RENT/LICENSE | RENT/LICENSE |
| Pipe monitoring, Electronic tally, Apps | | | | | |
| Telemetry Banwidth | — | — | Operation Cost | Operation Cost | Operation Cost |
| Low to high usage, tariff | | | | | |
| Transmission lines and devices - | — | SALE | — | SALE | — |

Of course, other arrangements could be made based on the particular situation.

In the above, there has been mention of certain items that are sold/leased/rented. Below are further examples of business arrangements that can be made for various portions of wired pipe system between a wired drill pipe supplier and the above listed participants. In some cases, advantages of such arrangements are also described.

For example, machined tubulars can be sold to Drilling Contractors, Pipe Yards or Operators. These are raw joints that have been machined to receive telemetry infrastructure components. This avoids a capital expense (CAPEX) on the wired-drill pipe supplier's books. These tubulars are purchased from a Pipe Supplier in one embodiment. The wired drillpipe supplier may have an optional agreement with a Pipe Supplier, especially for proprietary connections.

The communication infrastructure (e.g., transmission lines and transmission devices) could also be sold to Contractors, Pipe Yards or Operators. Service Companies and Equipment Suppliers may also buy the communication infrastructure to wire interface subs, ancillary components (e.g., jars) and along-string-measurement subs,

Alternatively the communication infrastructure could be leased/rented to Drilling Contractors, Pipe Yards or Operators. This may make business sense for Operators or Drilling Contractors if it is decided not to own these components. This will mean that these components are carried as CAPEX on the books of the wired drillpipe supplier.

As described above, the repeaters may be rented. The primary renter may be the Operator although, in certain cases, it might be the Drilling Contractor (such a case is where the Drilling Contractor is interested in turn-keying a wired drillpipe operation or deriving benefit from wired drillpipe applications) or another service provider. As discussed above, the repeaters have a shorter life-time than other wired drillpipe components and can be replaced on a bi-yearly cycle at the wellsite. Of course, such replacement could also incur a maintenance charge.

Further, ancillary components can optionally be rented or leased. The player involved will depend on the component. For example, the surface interface subwould be rented to a Drilling Contractor, while a downhole interface sub would be rented to a Service Company.

While FIGS. 7 and 8 have shown two example methods, it will be understood from the above that alternative methods could be formed.

While embodiments described herein have been described with reference to specific figures, it will be understood that various changes may be made and equivalents may be substituted for elements thereof without departing from the scope of the present disclosure. In addition, many modifications will be appreciated to adapt a particular instrument, situation, or material to the teachings of the present disclosure without departing from the scope thereof. Therefore, it is intended that the disclosure not be limited to the particular embodiments disclosed, but that the present disclosure will include all embodiments falling within the scope of the appended claims or the following description of possible embodiments.

### Embodiment 1

A first method of providing wired pipe drill services to an oil field operational participant is disclosed. The first method includes: providing a durable drilling component to the oil field operational participant, providing the durable element including receiving a sale payment from the oil field operational participant; and providing a plurality short life wired pipe drilling components to the oil field operational participant, providing the short life wired pipe drilling components including receiving a rental fee from the oil field operational participant, wherein the rental fee includes an operation cost portion that is based on a data rate to be used by the short life wired pipe drilling components.

### Embodiment 2

The first method according to any prior embodiment, wherein the short life wired pipe drilling component is a wired pipe repeater.

### Embodiment 3

The first method according to any prior embodiment, wherein the wired pipe repeater transmits payload data and overhead data and the overhead data is not included in the operation cost portion.

### Embodiment 4

The first method according to any prior embodiment, wherein providing the short life wired pipe drilling component includes replacing the short life wired pipe drilling component.

### Embodiment 5

The first method according to any prior embodiment, wherein the short life wired pipe drilling component is replaced on a time interval.

### Embodiment 6

The first method according to any prior embodiment, wherein the time interval is bi-yearly.

### Embodiment 7

The first method according to any prior embodiment, wherein the durable drilling component is a wired pipe segment that is configured to receive one or more elements of a communication infrastructure.

### Embodiment 8

The first method according to any prior embodiment, wherein the one or more elements of the communication infrastructure include a transmission device and one or more transmission lines.

### Embodiment 9

The first method according to any prior embodiment, wherein the transmission device is resonant coupler that includes one or more radio frequency antennas.

### Embodiment 10

The first method according to any prior embodiment, further comprising: providing a software product to the oil field operational participant, the software product allowing for the reception of a data from the at least one of the short life wired pipe drilling components wherein providing includes licensing the software product.

### Embodiment 11

A second method of providing wired pipe drill services to an oil field operational participant. The second method includes: providing a short life wired pipe drilling component to the oil field operational participant, providing the short life wired pipe drilling component including receiving a rental fee from the oil field operational participant, wherein the rental fee includes an operation cost portion that is based on a data rate to be used by the short life wired pipe drilling component; and providing a software product to the participant, the software product allowing for the reception of data from at least one of the short life wired pipe drilling components, wherein providing includes licensing the software product to the oil field operational participant.

### Embodiment 12

The second method according to any prior embodiment, wherein the short life wired pipe drilling component is a wired pipe repeater.

### Embodiment 13

The second method according to any prior embodiment, wherein the wired pipe repeater transmits provides payload data and overhead data and the overhead data is not included in the operation cost portion.

### Embodiment 14

The second method according to any prior embodiment, wherein providing the short life wired pipe drilling component includes replacing the short life wired pipe drilling component.

### Embodiment 15

The second method according to any prior embodiment, wherein the short life wired pipe drilling component is replaced on time interval.

### Embodiment 16

The second method according to any prior embodiment, wherein the time interval is bi-annual.

### Embodiment 17

The second method according to any prior embodiment, further comprising providing a durable drilling component is a wired pipe segment that is configured to receive one or more elements of a communication infrastructure.

### Embodiment 18

The second method according to any prior embodiment, wherein the one or more elements of the communication infrastructure include a transmission device and one or more transmission lines.

### Embodiment 19

The second method according to any prior embodiment, wherein the transmission device is a resonant couplers that includes one or more radio frequency antennas.

In support of the teachings herein, various analysis components may be used including a digital and/or an analog system. For example, controllers, computer processing systems, and/or geo-steering systems as provided herein and/or used with embodiments described herein may include digital and/or analog systems. The systems may have components such as processors, storage media, memory, inputs, outputs, communications links (e.g., wired, wireless, optical, or other), user interfaces, software programs, signal processors (e.g., digital or analog) and other such components (e.g., such as resistors, capacitors, inductors, and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (e.g., ROMs, RAMs), optical (e.g., CD-ROMs), or magnetic (e.g., disks, hard drives), or any other type that when executed causes a computer to implement the methods and/or processes described herein. These instructions may provide for equipment operation, control, data collection, analysis and other functions deemed relevant by a system designer, owner, user, or other such personnel, in addition to the functions described in this disclosure. Processed data, such as a result of an implemented method, may be transmitted as a signal via a processor output interface to a signal receiving device. The signal receiving device may be a display monitor or printer for presenting the result to a user. Alternatively or in addition, the signal receiving device may be memory or a storage medium. It will be appreciated that storing the result in memory or the storage medium may transform the memory or storage medium into a new state (i.e., containing the result) from a prior state (i.e., not containing the result). Further, in some embodiments, an alert signal may be transmitted from the processor to a user interface if the result exceeds a threshold value.

Furthermore, various other components may be included and called upon for providing for aspects of the teachings herein. For example, a sensor, transmitter, receiver, transceiver, antenna, controller, optical unit, electrical unit, and/or electromechanical unit may be included in support of the various aspects discussed herein or in support of other functions beyond this disclosure.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” or “substantially” used in connection with a quantity is inclusive of the stated value and has the meaning dictated by the context (e.g., it includes the degree of error associated with measurement of the particular quantity). For example, the phrase “substantially constant” is inclusive of minor deviations with respect to a fixed value or direction, as will be readily appreciated by those of skill in the art.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the present disclosure.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

Accordingly, embodiments of the present disclosure are not to be seen as limited by the foregoing description, but are only limited by the scope of the appended claims.

1. A method of providing wired pipe drill services to an oil field operational participant, the method comprising:
providing a durable drilling component to the oil field operational participant, providing the durable element including receiving a sale payment from the oil field operational participant; and
providing a plurality short life wired pipe drilling components to the oil field operational participant, providing the short life wired pipe drilling components including receiving a rental fee from the oil field operational participant, wherein the rental fee includes an operation cost portion that is based on a data rate to be used by the short life wired pipe drilling components.

2. The method of claim 1, wherein the short life wired pipe drilling component is a wired pipe repeater.

3. The method of claim 2, wherein the wired pipe repeater transmits payload data and overhead data and the overhead data is not included in the operation cost portion.

4. The method of claim 1, wherein providing the short life wired pipe drilling component includes replacing the short life wired pipe drilling component.

5. The method of claim 4, wherein the short life wired pipe drilling component is replaced on a time interval.

6. The method of claim 5, wherein the time interval is bi-yearly.

7. The method of claim 1, wherein the durable drilling component is a wired pipe segment that is configured to receive one or more elements of a communication infrastructure.

8. The method of claim 7, wherein the one or more elements of the communication infrastructure include a transmission device and one or more transmission lines.

9. The method of claim 8, wherein the transmission device is resonant coupler that includes one or more radio frequency antennas.

10. The method of claim 1, further comprising:
providing a software product to the operator, the software product allowing for the reception of a data from the at least one of the short life wired pipe drilling components wherein providing includes licensing the software product.

11. A method of providing wired pipe drill services to an oil field operational participant, the method comprising:
providing a short life wired pipe drilling component to the oil field operational participant, providing the short life wired pipe drilling component including receiving a rental fee from the oil field operational participant, wherein the rental fee includes an operation cost portion that is based on a data rate to be used by the short life wired pipe drilling component; and
providing a software product to the oil field operational participant, the software product allowing for the reception of data from at least one of the short life wired pipe drilling components, wherein providing includes licensing the software product to the oil field operational participant.

12. The method of claim 11, wherein the short life wired pipe drilling component is a wired pipe repeater.

13. The method of claim 12, wherein the wired pipe repeater transmits provides payload data and overhead data and the overhead data is not included in the operation cost portion.

14. The method of claim 1, wherein providing the short life wired pipe drilling component includes replacing the short life wired pipe drilling component.

15. The method of claim 14, wherein the short life wired pipe drilling component is replaced on a time interval.

16. The method of claim 15, wherein the time interval is bi-annual.

17. The method of claim 11, further comprising providing a durable drilling component is a wired pipe segment that is configured to receive one or more elements of a communication infrastructure.

18. The method of claim 17, wherein the one or more elements of the communication infrastructure include a transmission device and one or more transmission lines.

19. The method of claim 18, wherein the transmission device is a resonant couplers that includes one or more radio frequency antennas.
